(19) United States
(12) Patent Application Publication
(10) Pub. No.: US 2004/0102299 A1
(43) Pub. Date: May 27, 2004

(54) Process and device for assembling groups of filter segments

(75) Inventors: Ralf Meyer, Gerdau (DE); Sonke Horn, Geesthacht (DE); Matthias Jahnke, Hamburg (DE); Andreas Rinke, Bad Oldesloe (DE)

Correspondence Address: GREENBLUM & BERNSTEIN, P.L.C., 1950 ROLAND CLARKE PLACE, RESTON, VA, 20191, US

(73) Assignee: HAUNI Maschinenbau AG, Hamburg (DE)

(21) Appl. No.: 10/645,606

(22) Filed: Aug. 22, 2003

(30) Foreign Application Priority Data
Sep. 2, 2002 (EP) 02 019 534.3

(51) Int. Cl. B31C 13/00

(52) U.S. Cl. 493/39

(57) ABSTRACT

Process and device for assembling groups of filter segments in a rod process. The process includes providing a plurality of different types of filter segments, assembling the plurality of different types of filter segments into a group of filter segments, and dividing the group of filter segments into at least two part groups of filter segments. The filter segments of each part group adjoin each other in a lengthwise axial manner. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 02 019 534.3, filed on Sep. 2, 2002, the disclosure of which is expressly incorporated by reference herein in its entirety.

### BACKGROUND OF THE INVENTION

1. Field of the Invention

The present invention relates to a process and device for assembling groups of filter segments to produce multi-segment filters of the tobacco processing industry in a rod process. In this manner, at least two different types of filter segments are provided per multi-segment filter. The invention further relates to a process for producing multi-segment filters of the tobacco processing industry in a rod process.

2. Discussion of Background Information

In the tobacco processing industry, it is desirable to produce multi-segment filters that include different segments, i.e., different materials, such as, e.g., cellulose acetate, paper, fibrous web, granular material, sintered elements, hollow cylinders or hollow chambers and capsules and the like. After groups of filter segments have been formed, e.g., in a rod process, multi-segment filters, which within the scope of this invention also include the term “composite filters,” are wrapped with wrapping material, such as, e.g., paper, and then divided into 2-fold, 4-fold or 6-fold long filter rods in order to be further processed.

A rod forming device is known from German Patent Application No. DE-OS 24 52 749, which corresponds to Great Britain Application No. GB 15 22 139, in which in a group forming device operating in a transverse process or in a cross-axial conveying direction groups of filter segments or groups of filter rods are formed and then transferred to the rod forming device such that the groups of filter rods can be wrapped with wrapping material in a lengthwise axial manner.

A typical rod forming device of the Hauni Maschinenbau AG is called KDF 2 ED, and a typical group forming device of the Hauni is called GC E. Both devices are known to those ordinarily skilled in the art.

Regarding the transfer of the formed groups from the group forming device to the rod forming device, reference is made to German Patent Application No. DE-OS 25 34 666, which corresponds to U.S. Pat. No. 4,044,659, and both of these documents are expressly incorporated by reference herein in their entireties. Still further, the above-noted German Patent Application No. DE-OS 24 52 749 is likewise expressly incorporated by reference herein in its entirety.

A device for assembling groups of filter segments to produce multi-segment filters of the tobacco processing industry in a rod process is known from German Patent Application No. DE 101 55 292.0, in which at least two different types of filter segments are provided per multi-segment filter and the device can be divided into a plurality of independent function units. Through operation of this device, a great variability is possible in the production of multi-segment filters. It is further noted that German Patent Application No. 101 55 292.0 is expressly incorporated by reference herein in its entirety.

### SUMMARY OF THE INVENTION

The present invention provides for the transfer of filter segments combined into groups, i.e., after the assembly of these groups, to produce wrapped multi-segment filters in a safe manner. In particular, the invention contemplates the use of large groups of filter segments with a relatively large number of individual segments.

Accordingly, the invention relates to a process for assembling groups of filter segments to produce multi-segment filters of the tobacco processing industry in a rod process. In this manner, at least two different types of filter segments are provided per multi-segment filter and, per group, all filter segments are provided to produce at least one multi-segment filter. Moreover, the group of filter segments is divided into at least two part groups of filter segments adjoining in a lengthwise axial manner.

Through the process according to the invention, handling the relatively long group of filter segments is facilitated by shorter part groups that are conveyed and correspondingly transferred. With correspondingly long groups, the transfer of the part groups, in particular, from a cross-axial conveying direction during the assembly of the group into a lengthwise axial conveying direction into a rod, crosswise displacements of the segments can occur due to cross-axial forces, which can lead to a disintegration of the group.

Within the scope of this invention, the term “adjoining in a lengthwise axial manner” includes in particular a juxtaposition of segments in a lengthwise axial filter direction, whereby in particular the areas or surfaces permeable for the tobacco smoke are adjacent to one another.

When a group of filter segments adjoining in a lengthwise axial manner is first assembled and subsequently at least two part groups are formed by spacing a first part of filter segments adjoining in a lengthwise axial manner from a second part of filter segments adjoining in a lengthwise axial manner, a particularly simple handling of the group or part groups is possible. The filter segments first arranged together in a lengthwise axial manner are spaced apart from one another in order to thus form part groups that are easier to handle. Provided the spacing takes place by pushing them apart in a cross-axial manner, such as, e.g., by staggering, a particularly effective distancing of the part groups from one another is possible. It is also possible to carry out the spacing by pushing them apart in a lengthwise axial manner.

A first part group preferably includes different segments from a second part group, so that it is possible to produce very variable multi-segment filters. A particularly good manageability results if at least one end of the respective part groups is aligned in the conveying direction in a cross-axial manner and the two ends of the part groups are preferably aligned with one another in a cross-axial manner. In this case a very simplified transfer from a cross-axial conveying direction to a lengthwise axial conveying direction in a rod of segments of multi-segment filters is possible.

According to the invention, a process is provided for assembling groups of filter segments to produce multi-segment filters of the tobacco processing industry in a rod process. In this way, at least two different types of filter segments are provided per multi-segment filter and the group is divided into at least two part groups, such that the part groups are arranged in series in a cross-axial conveying direction. Through this solution according to the invention, the handling of the segments of the group of filter segments is simplified.

The part groups arranged in series in the conveying direction are preferably aligned in a lengthwise axial manner, so that at least one end of the part groups is aligned with one another in the conveying direction. At least one first part group preferably includes different filter segments from at least one second part group with this process according to the invention, too.

A very effective and safe process for producing multi-segment filters of the tobacco processing industry in a rod process is provided with a process described above for assembling groups of filter segments, so that the assembled groups or part groups of filter segments are arranged in series in a lengthwise axial manner. In this way, the assembled groups or part groups form a rod that is conveyed in a lengthwise axial manner and the rod is wrapped with a wrapping material. Subsequently, the multi-segment filters or multiple-length multi-segment filters are severed from the rod.

If the part groups of filter segments are transferred from a crosswise axial conveying direction to a lengthwise axial conveying direction, a very effective and space-saving process operation is possible. The division of the group of filter segments into at least two part groups preferably occurs in a process step before transfer to the lengthwise axial conveying direction.

The invention further relates to a device for assembling groups of filter segments to produce multi-segment filters of the tobacco processing industry in a rod process, so that at least two different types of filter segments are provided per multi-segment filter. In this manner, the device includes at least a first device that can assemble the filter segments into groups, and a second device to divide the groups into part groups.

A very safe handling of the groups or part groups of segments of multi-segment filters is possible through the device according to the invention. The second device preferably includes a device for moving part groups apart. When the moving device is a staggered drum, a particularly simple realization of the device according to the invention is possible. Moreover, the second device preferably includes a sliding drum that displaces at least one of the part groups in a lengthwise axial manner, so that at least one end of the part groups respectively is aligned with one another in a crosswise axial manner. The further manageability of the part groups is simplified through this preferable further development of the invention.

The present invention is directed to a process for assembling groups of filter segments in a rod process. The process includes providing a plurality of different types of filter segments, assembling the plurality of different types of filter segments into a group of filter segments, and dividing the group of filter segments into at least two part groups of filter segments. The filter segments of each part group adjoin each other in a lengthwise axial manner.

In accordance with a feature of the invention, the process can further include forming a multi-segment filter with at least two of the different types of filter segments. All filter segments of the group of filter segments may be combined to form at least one multi-segment filter.

The group of filter segments may be assembled by arranging the filter segments to adjoin each other in a lengthwise axial manner, and the at least two part groups can be formed by spacing a first part of the group of filter segments adjoining in a lengthwise axial manner from a second part of the group of filter segments adjoining in a lengthwise axial manner. The spacing of first and second parts of the group of filter segments may include pushing the first and second parts apart in a cross-axial manner. Further, the first part group can include different filter segments than the second part group.

According to a feature of the invention, the process can further include aligning the at least two part groups crosswise to the conveying direction and aligning at least one end of the at least two part groups in the conveying direction.

The present invention is directed to a process for assembling groups of filter segments in a rod process. The process includes forming a group of filter segments composed of at least two different types of filter segments, and dividing the group of filter segments into at least two part groups arranged in series in a cross-axial conveying direction.

In accordance with a feature of the invention, the filter segments may be arranged to produce multi-segment filters of the tobacco processing industry.

The process can further include aligning the part groups in a lengthwise axial manner crosswise to the conveying direction, and conveying the aligned part groups so that at least one end of the part groups is aligned in the conveying direction.

The invention is directed to a process for producing multi-segment filters of the tobacco processing industry in a rod process. The process includes providing a plurality of different types of filter segments, assembling the plurality of different types of filter segments into a group of filter segments, and dividing the group of filter segments into at least two part groups of filter segments. The filter segments of each part group adjoin each other in a lengthwise axial manner. The process also includes aligning the at least two part groups of filter segments in series in a lengthwise axial manner to form a rod, conveying the rod in a lengthwise axial direction, and wrapping the rod with a wrapping material.

In accordance with the invention, the process can further include severing one of multi-segment filters and multiple-length multi-segment filters from the rod. The part groups of filter segments may be transferred from a cross-axial conveying direction to a lengthwise axial conveying direction. The dividing of the group of filter segments into at least two part groups can occur prior to the conveying of the rod in the lengthwise axial direction.

The present invention is directed to a device for assembling groups of filter segments in a rod process that includes at least two units structured and arranged to provide at least two different types of filter segments, a first assembling device structured and arranged to assemble the at least two different types of filter segments into groups, and a separation device structured and arranged to divide the groups into part groups.

According to the invention, the device may be structured and arranged to produce multi-segment filters of the tobacco processing industry.

In accordance with a feature of the invention, the separation device can include a device for moving the part groups apart from each other.

According to another feature of the present invention, the device can include a staggered drum.

Further, the separation device can also include a sliding drum structured and arranged to displace at least one of the part groups in a lengthwise axial manner, such that at least one end of the displaced part groups can be aligned in a crosswise axial manner.

According to the invention, a cigarette production machine can include the above-noted device.

The present invention is directed to a process for producing rod-shaped articles. The process includes providing a plurality of segments of different type, arranging the plurality of segments of different type into groups aligned in a cross conveying direction, separating the groups into at least two part groups, and aligning the at least two part groups to form a rod of segments.

The process may further include conveying at least one of the at least two part groups in the cross conveying direction. The process can also include conveying the at least two part groups in succession in the conveying direction. At least one end of the at least two part groups conveyed in the conveying direction can be aligned in the cross conveying direction. The process may also include separating the at least two part groups in a conveying direction, and can also include aligning the at least two part groups in an axial direction, thereby forming the rod. Moreover, the process can include conveying the rod in the axial direction, wrapping the rod with wrapping paper, and dividing the rod into a plurality of multi-segment rods.

In accordance with another feature of the instant invention, the plurality of different types of segments of different types may include soft elements.

Further, the groups of segments can be arranged to include two segments of each different type. Each group includes at least one double length segment and at least two single length segments of a same type.

The invention is directed to an apparatus for assembling groups of filter segments in a rod process that includes a plurality of filter segment units. Each filter segment unit is structured and arranged to provide different types of filter segments. The apparatus also includes an assembling device coupled to the plurality of filter segment units to axially align the produced plurality of filter segments of different types, and a separation device coupled to the assembling device to divide the axially aligned filter segments into part groups.

In accordance with still yet another feature of the present invention, the separation device can include a staggered drum to move the part groups apart from each other. The separation device can further include a sliding drum structured and arranged to move at least one of the part groups in an axial direction crosswise to a conveying direction, to successively convey the part groups in the conveying direction. Moreover, an insertion wheel and a transfer conveyor are provided. The partial groups are axially aligned on the transfer conveyor by said insertion wheel in order to form a rod.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a side view of a device according to the invention for assembling groups of filter segments to produce multi-segment filters of the tobacco processing industry in a rod process; and

FIG. 2 diagrammatically illustrates the filter segments assembled in the respective units of the device according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

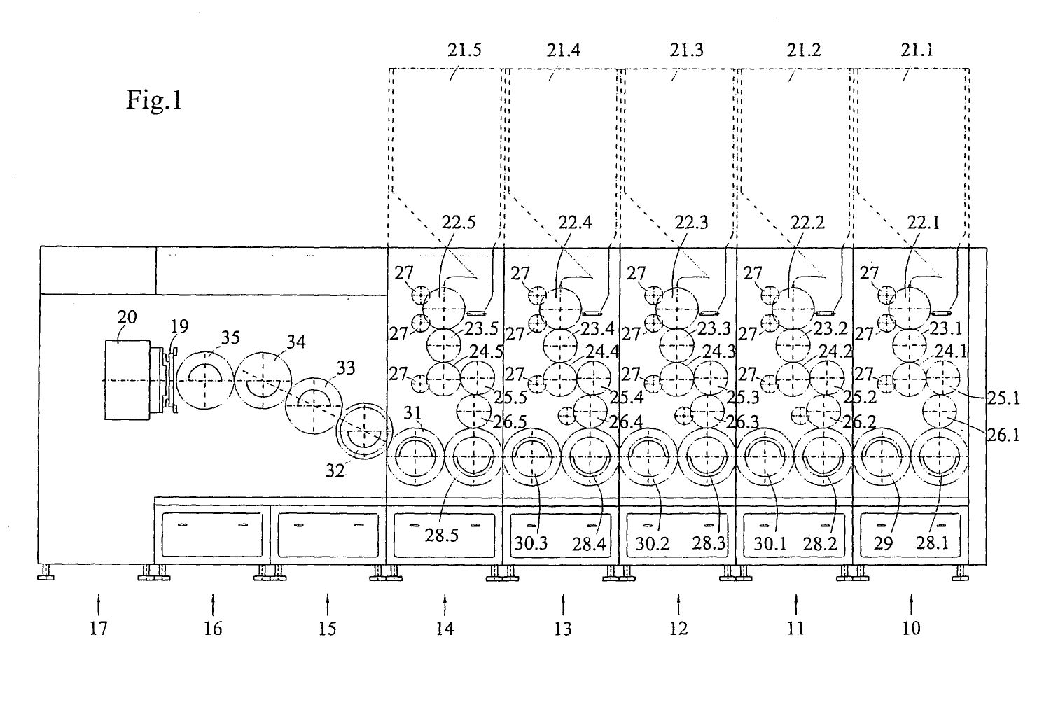

A multi-segment filter production device with a device according to the invention for assembling groups of filter segments to produce multi-segment filters is shown in a diagrammatic side view in FIG. 1. The multi-segment filter production device is divided into corresponding units. The device can be divided into a plurality of independent function units according to commonly owned German Patent Application No. DE 101 55 292.0. In this exemplary embodiment, the function units are formed as a plurality of soft element units 10-14, two transfer units 15 and 16, which can also be represented as one transfer unit, and a corresponding rod forming unit 17 that is only represented in a very diagrammatic form.

Soft element units 10-14 are similar to one another, and can correspond essentially to the soft element units in FIG. 5a) of the above-noted German Patent Application No. DE 101 55 292.0. Regarding all further details of these soft element units, reference is explicitly made to German Patent Application No. DE 101 55 292.0. Soft element units 11, 12 and 13 differ from soft element units 10 and 14 in that a further circular knife 27 is provided by which the fed filter elements are cut up one additional time. In the exemplary embodiment, five soft element units 10-14 have been used. However, instead of or in addition to these soft element units, hard element units can also be used. In this regard, the soft elements can include, e.g., a filter element of cellulose acetate or a fibrous web, and the hard filter elements can include, e.g., sintered elements, hollow cylinders or hollow chambers and capsules that can also be filled with, e.g., granular material. For further discussion of the corresponding hard element unit, reference is made to FIG. 6a) of German Patent Application No. DE 101 55 292.0.

Soft element units 10-14 of FIG. 1 comprise corresponding storage containers 21.1-21.5 that can feature filter elements of, e.g., 12-fold working length or 16-fold working length. In soft element unit 10, filter elements of n-fold working length are removed by removal drum 22.1 and cut up into filter elements of smaller working length by circular knife 27. If there are only two circular knives utilized, filters of 12-fold working length are cut up into filter elements of 4-fold working length. If the upper circular knife is a circular knife and the lower circular knife is two circular knives one behind the other in the back plane, filter elements of 16-fold working length are cut up into respectively filter elements of 4-fold working length.

Subsequently, filter elements of 4-fold working length are transferred to a staggered drum 23.1 in which the filter elements are staggered in order subsequently to be first displaced in a sliding/cutting drum 24.1 aligned in a cross-axial manner, in order finally to make a further cut by a circular knife 27 that cuts filter elements of 4-fold working length into filter elements of 2-fold working length. In the following staggered drum 25.1, these filter elements are staggered in order to be subsequently aligned in a cross-axial manner in a sliding/transfer drum 26.1 and then to be deposited on an assembly drum 28.1.

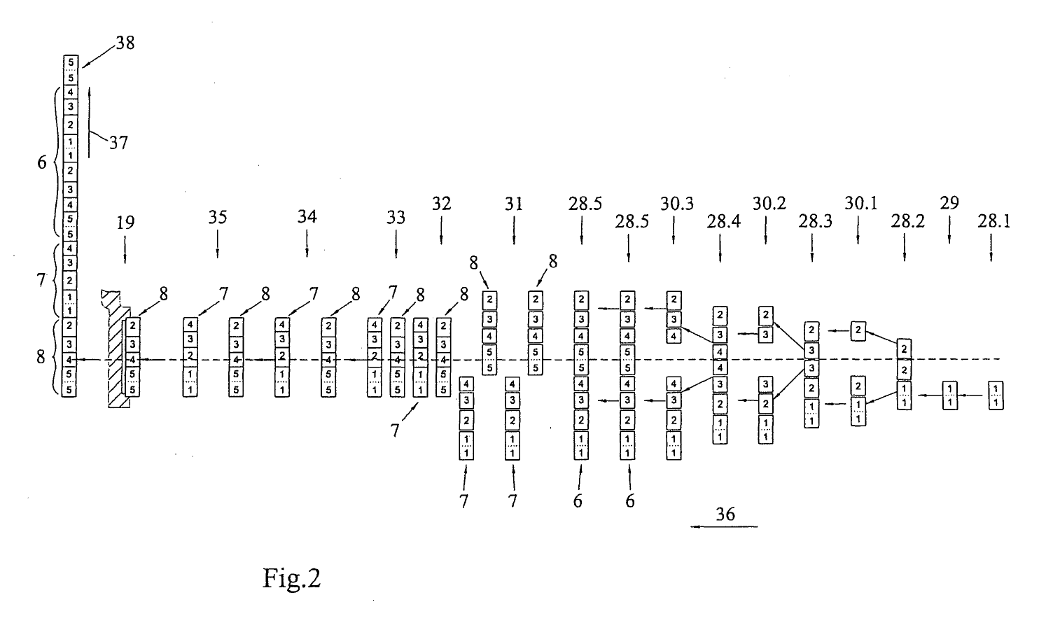

Filter elements 1 of double working length are thus deposited in soft element unit 10, and they are then transferred by a transfer drum 29 to an assembly drum 28.2 of soft element unit 11. Two filter elements 2 of single working length are then placed on assembly drum 28.2, and then pushed apart in a lengthwise axial manner in spreader drum 30.1. In this regard, reference is made in particular to FIG. 2, which shows the position of the respective filter elements 1-5. More information will be provided below regarding the corresponding positions.

Soft element unit 11 differs from soft element unit 10 in that another circular knife 27 is arranged in the area of sliding/transfer drum 26.2 that cuts the filter elements of double working length into two filter elements 2 of single working length. Moreover, soft element unit 11 differs from soft element unit 10 in that a spreader drum 30.1 is used instead of transfer drum 29. Soft element units 12 and 13 also comprise corresponding spreader drums 30.2 or 30.3 respectively by which correspondingly inserted segments or filter elements 1-5 can be pushed apart or spread.

Soft element unit 14 again essentially corresponds to soft element unit 10, however, a staggered drum 31 is used instead of transfer drum 29, in accordance with the invention. In this staggered drum, the assembled segments or filter elements 1-5 (which are arranged to form a group 6 that, in the exemplary embodiment, includes 8 filter elements 1-5, i.e., 6 filter elements of single working length 2, 2, 3, 3, 4, 4 and two filter elements 1, 1 and 5, 5 of double working length) are divided into two part groups 7 and 8. In this regard, the part groups can be staggered in order then to be aligned in a cross-axial manner in sliding drum 32 and compressed in a subsequent wobble drum 33. Part groups 7 and 8 are subsequently transferred to a transfer drum 34, accelerated by an accelerator drum 35, and inserted in an insertion wheel 19 of a transfer conveyor 20 in order to be transferred in a known manner in a multi-segment filter rod that is subsequently wrapped with filter paper and cut to length. With regard to the transfer of the groups of multi-segment filters from a cross-axial conveying direction to a lengthwise axial conveying direction in the rod, reference is made in particular to German Patent Application No. DE-OS 25 34 666. According to the invention, at least two part groups of fewer filter segments are formed from a group of a relatively large number of filter segments in order to facilitate their handling.

The rod forming unit, which is shown in diagrammatic form as 17 in FIG. 1, is, e.g., a conventional rod forming device with the above-noted designation KDF 2 ED.

FIG. 2 shows in diagrammatic form for the respective drums how filter segments 1-5 are correspondingly arranged. Above the filter segments, arrows indicate in which drum the filter elements are correspondingly arranged. The reference numbers of the respective drums are provided in this respect.

First soft elements 1 of double working length are inserted in assembly drum 28.1 in the cross-axial conveying direction 36 and transferred from transfer drum 29 to an assembly drum 28.2, in which two soft elements 2, which have a single working length, are also inserted. Filter elements 1 and 2 are pushed apart in spreader drum 30.1, as shown, and are transferred to an assembly drum 28.3 in which two soft elements 3, which also have a single working length, are inserted. In this case, soft elements 3 are inserted in the gap being formed by the prior spreading. The filter elements are pushed apart or spread again in the next spreader drum 30.2 such that a corresponding gap forms between soft elements 3. After transfer to assembly drum 28.4, two soft elements 4, which have a single working length, are inserted there into the gap. The filter elements are again spread in spreader drum 30.3 and transferred to assembly drum 28.5 in order to be completed with the insertion of soft element 5 that has a double working length.

A assembled soft elements 1-5 formed in this way represent a group 6 of filter elements in order to produce a multi-segment filter of double working length. In this manner, part of soft element 1 is used for another group, e.g., the following group, to form corresponding multi-segment filters, and a soft element 1 of the previous group is added to this multi-segment filter of double working length.

After the transfer of group 6 of filter elements 1-5 to staggered drum 31, they are staggered as shown, in order to form two part groups 7 and 8, i.e., a first filter segment part group 7 and a second filter segment part group 8. The filter segment part groups are transferred to a sliding drum 32 in which they are displaced accordingly in an aligned, cross-axial manner. Filter elements 1-5 of filter segment part groups 7 and 8 are pushed together in a wobble drum 33 in order to produce compact part groups. After transfer to a transfer drum 34, the correspondingly formed filter segment part groups 7 and 8 are accelerated in an accelerator drum 35 and placed on an insertion wheel 19 of a transfer conveyor 20 to be transferred in a known manner to a rod forming device, in order to form an endless rod by wrapping the filter segments or filter segment groups with a wrapping strip. Subsequently, the multi-segment filters, which contain at least two different components, are formed in a predetermined length by cutting. Conveying direction 37 of filter rod 38 is hereby axially lengthwise. The corresponding part groups 7 and 8 and group 6, which is a composition of part groups 7 and 8, are also shown diagrammatically on rod 38.

In order to achieve the simplest and safest possible handling of filter segments and to transfer double-length, unwrapped filter rods, filter segment groups are assembled from filter segments of different lengths, staggered in at least two filter segment groups, and aligned and transferred to grooves, if necessary of different lengths, of an accelerator wheel. The filter segment groups are then transferred to an insertion wheel with, if necessary, modified grooves and transferred to a filter production machine that wraps filters with filter wrapping paper in a lengthwise process. The corresponding modifications of the grooves of the accelerator wheel and of the insertion wheel are necessary if part groups 7 and 8 are of, e.g., different lengths or contain segments that are themselves of different sizes such that suction openings have to be present at respectively different locations.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

1,5 Soft element of double working length

2-4 Soft element of single working length

6 Filter segment group

7 First filter segment part group

8 Second filter segment part group

10-14 Soft element unit

15 Transfer unit

16 Transfer unit

17 Rod forming unit

19 Insertion wheel

20 Transfer conveyor

21.1-21.5 Storage container

22.1-22.5 Removal drum

23.1-23.5 Staggered drum

24.1-24.5 Sliding/cutting drum

25.1-25.5 Staggered drum

26.1-26.5 Sliding/transfer drum

27 Circular knife

28.1-28.5 Assembly drum

29 Transfer drum

30.1-30.3 Spreader drum

31 Staggered drum

32 Sliding drum

33 Wobble drum

34 Transfer drum

35 Accelerator drum

36 Conveying direction

37 Conveying direction

38 Filter rod

What is claimed:

1. A process for assembling groups of filter segments in a rod process, comprising:
providing a plurality of different types of filter segments;
assembling the plurality of different types of filter segments into a group of filter segments; and
dividing the group of filter segments into at least two part groups of filter segments, wherein the filter segments of each part group adjoin each other in a lengthwise axial manner.

2. The process in accordance with claim 1, further comprising forming a multi-segment filter with at least two of the different types of filter segments.

3. The process in accordance with claim 2, wherein all filter segments of the group of filter segments are combined to form at least one multi-segment filter.

4. The process in accordance with claim 1, wherein the group of filter segments is assembled by arranging the filter segments to adjoin each other in a lengthwise axial manner; and
the at least two part groups are formed by spacing a first part of the group of filter segments adjoining in a lengthwise axial manner from a second part of the group of filter segments adjoining in a lengthwise axial manner.

5. The process in accordance with claim 4, wherein the spacing of first and second parts of the group of filter segments comprises pushing the first and second parts apart in a cross-axial manner.

6. The process in accordance with claim 4, wherein the first part group comprises different filter segments than the second part group.

7. The process in accordance with claim 1, further comprising aligning the at least two part groups crosswise to the conveying direction and aligning at least one end of the at least two part groups in the conveying direction.

8. A process for assembling groups of filter segments in a rod process, comprising:
forming a group of filter segments composed of at least two different types of filter segments; and
dividing the group of filter segments into at least two part groups arranged in series in a cross-axial conveying direction.

9. The process in accordance with claim 8, wherein the filter segments are arranged to produce multi-segment filters of the tobacco processing industry.

10. The process in accordance with claim 8, further comprising:
aligning the part groups in a lengthwise axial manner crosswise to the conveying direction; and
conveying the aligned part groups so that at least one end of the part groups is aligned in the conveying direction.

11. A process for producing multi-segment filters of the tobacco processing industry in a rod process, comprising:
providing a plurality of different types of filter segments;
assembling the plurality of different types of filter segments into a group of filter segments;
dividing the group of filter segments into at least two part groups of filter segments, wherein the filter segments of each part group adjoin each other in a lengthwise axial manner;
aligning the at least two part groups of filter segments in series in a lengthwise axial manner to form a rod;
conveying the rod in a lengthwise axial direction; and
wrapping the rod with a wrapping material.

12. The process in accordance with claim 11, further comprising severing one of multi-segment filters and multiple-length multi-segment filters from the rod.

13. The process in accordance with claim 12, wherein the part groups of filter segments are transferred from a cross-axial conveying direction to a lengthwise axial conveying direction.

14. The process in accordance with claim 12, wherein the dividing of the group of filter segments into at least two part groups occurs prior to the conveying of the rod in the lengthwise axial direction.

15. A device for assembling groups of filter segments in a rod process, comprising:
at least two units structured and arranged to provide at least two different types of filter segments;
a first assembling device structured and arranged to assemble the at least two different types of filter segments into groups; and
a separation device structured and arranged to divide the groups into part groups.

16. The device in accordance with claim 15, wherein said device is structured and arranged to produce multi-segment filters of the tobacco processing industry.

17. The device in accordance with claim 15, wherein said separation device comprises a device for moving the part groups apart from each other.

18. The device in accordance with claim 15, wherein said device comprises a staggered drum.

19. The device in accordance with claim 15, wherein said separation device further comprises a sliding drum structured and arranged to displace at least one of the part groups in a lengthwise axial manner, such that at least one end of the displaced part groups is aligned in a crosswise axial manner.

20. A cigarette production machine comprising the device in accordance with claim 15.

21. A process for producing rod-shaped articles, comprising:
providing a plurality of segments of different type;
arranging the plurality of segments of different type into groups aligned in a cross conveying direction;
separating the groups into at least two part groups; and
aligning the at least two part groups to form a rod of segments.

22. The process in accordance with claim 21, further comprising conveying at least one of the at least two part groups in the cross conveying direction.

23. The process in accordance with claim 22, further comprising conveying the at least two part groups in succession in the conveying direction.

24. The process in accordance with claim 23, wherein at least one end of the at least two part groups conveyed in the conveying direction are aligned in the conveying direction.

25. The process in accordance with claim 23, further comprising separating the at least two part groups in a conveying direction.

26. The process in accordance with claim 25, further comprising aligning the at least two part groups in an axial direction, thereby forming the rod.

27. The process in accordance with claim 26, further comprising:
conveying the rod in the axial direction;
wrapping the rod with wrapping paper; and
dividing the rod into a plurality of multi-segment rods.

28. The process in accordance with claim 21, wherein the plurality of different types of segments of different types comprise soft elements.

29. The process in accordance with claim 21, wherein the groups of segments are arranged to include two segments of each different type.

30. The process in accordance with claim 29, wherein each group includes at least one double length segment and at least two single length segments of a same type.

31. An apparatus for assembling groups of filter segments in a rod process, comprising:
a plurality of filter segment units, wherein each filter segment unit is structured and arranged to provide different types of filter segments;
an assembling device coupled to said plurality of filter segment units to axially align the produced plurality of filter segments of different types; and
a separation device coupled to said assembling device to divide the axially aligned filter segments into part groups.

32. The apparatus in accordance with claim 31, wherein said separation device comprises a staggered drum to move the part groups apart from each other.

33. The apparatus in accordance with claim 32, wherein said separation device further comprises a sliding drum structured and arranged to move at least one of the part groups in an axial direction crosswise to a conveying direction, to successively convey the part groups in the conveying direction.

34. The apparatus in accordance with claim 33, further comprising an insertion wheel and a transfer conveyor, wherein the partial groups are axially aligned on the transfer conveyor by said insertion wheel in order to form a rod.
